(19) United States
(12) Patent Application Publication
(10) Pub. No.: US 2026/0276905 A1
(43) Pub. Date: Sep. 17, 2026

(54) OPTICAL CONNECTION ASSEMBLY

(71) Applicant: SUMITOMO ELECTRIC INDUSTRIES, LTD., Osaka (JP)

(72) Inventors: Masato TANAKA, Osaka (JP); Hidehisa TAZAWA, Osaka (JP); Osamu SHIMAKAWA, Osaka (JP)

(73) Assignee: SUMITOMO ELECTRIC INDUSTRIES, LTD., Osaka (JP)

(21) Appl. No.: 19/560,486

(22) Filed: Mar. 9, 2026

(30) Foreign Application Priority Data
Mar. 12, 2025 (JP) 2025-039062

(51) Int. Cl. G02B 6/40; G02B 3/00; G02B 6/26; G02B 6/32

(52) U.S. Cl. CPC G02B 6/40; G02B 3/0087; G02B 6/262; G02B 6/268; G02B 6/327

(57) ABSTRACT

An optical connection assembly includes: a first optical fiber assembly including a first fiber end face and first cores; a second optical fiber assembly including a second fiber end face and second cores; a first lens including a first lens rear face and a first lens front face; and a second lens including a second lens rear face and a second lens front face. The first fiber end face and the first lens rear face are inclined with respect to a plane perpendicular to a central axis of the first lens. The second fiber end face and the second lens rear face are inclined with respect to a plane perpendicular to a central axis of the second lens. The first lens is a lens in which at least one of the first lens rear face and the first lens front face is curved. The second lens is a GRIN lens.

### CROSS REFERENCE

The present application claims priority based on Japanese Patent Application No. 2025-039062 filed on Mar. 12, 2025, the entire contents of which are incorporated herein by reference.

### TECHNICAL FIELD

The present disclosure relates to an optical connection assembly.

### BACKGROUND

Conventionally, an optical connection assembly that optically couples two optical fibers is known (see, for example, Japanese Unexamined Patent Publication No. 2017-181791 and Japanese Unexamined Patent Publication No. 2023-114160). In such an optical connection assembly, two convex lenses are arranged between two optical fibers facing each other, and the two optical fibers are optically coupled by these convex lenses.

### SUMMARY

An optical connection assembly of the present disclosure includes: a first optical fiber assembly including a first fiber end face and a plurality of first cores extending from the first fiber end face; a second optical fiber assembly including a second fiber end face facing the first fiber end face and a plurality of second cores extending from the second fiber end face and optically coupling to the plurality of first cores; a first lens including a first lens rear face facing the first fiber end face and a first lens front face facing a side opposite to the first lens rear face, the first lens being disposed between the first fiber end face and the second fiber end face; and a second lens including a second lens rear face facing the second fiber end face and a second lens front face facing a side opposite to the second lens rear face, the second lens being disposed between the first lens front face and the second fiber end face. Each of the first fiber end face and the first lens rear face is inclined with respect to a plane perpendicular to a central axis of the first lens. Each of the second fiber end face and the second lens rear face is inclined with respect to a plane perpendicular to a central axis of the second lens. The first lens is a lens in which at least one of the first lens rear face and the first lens front face is a curved face. The second lens is a GRIN (GRaded Index) lens in which each of the second lens rear face and the second lens front face is a flat face.

### BRIEF DESCRIPTION OF THE DRAWINGS

FIG. 1 is a cross-sectional view illustrating an optical connection assembly of an embodiment.

FIG. 2 is a schematic diagram illustrating a configuration of the optical connection assembly of FIG. 1.

FIG. 3 is a diagram illustrating a lens action of a GRIN lens.

FIG. 4 is a diagram illustrating an effect of the optical connection assembly of FIG. 1.

FIG. 5 is a diagram illustrating an effect of the optical connection assembly of FIG. 1.

FIG. 6 is a graph showing focal length characteristics of a GRIN lens.

FIG. 7 is a graph showing focal length characteristics of a plano-convex lens.

FIG. 8 is a table showing results of confirming an effect of the optical connection assembly of FIG. 1.

FIG. 9 is a cross-sectional view illustrating an optical connection assembly of Modification 1.

FIG. 10 is a schematic diagram illustrating an optical connection assembly of Modification 2.

FIG. 11 is a schematic diagram illustrating an optical connection assembly of Comparative Example 1.

FIG. 12 is a schematic diagram illustrating an optical connection assembly of Comparative Example 2.

FIG. 13 is a diagram for describing a problem of the optical connection assembly of FIG. 12.

FIG. 14 is a diagram for describing a problem of the optical connection assembly of FIG. 12.

### DETAILED DESCRIPTION

In the case of using two convex lenses in the conventional optical connection assembly, a part of the light reflected by the curved faces of the convex lenses tend to enter the end face of the optical fiber as return light. When such return light is incident on the end face of the optical fiber, in unidirectional transmission, operational instability and performance degradation of a device (for example, an amplifier or laser) disposed upstream of the optical connection assembly may occur, and in bidirectional transmission, quality degradation of signals in opposite directions may occur. Therefore, in the optical connection assembly described above, the quality of optical transmission may be degraded due to the influence of the return light.

The present disclosure provides an optical connection assembly that improves the quality of optical transmission.

According to the present disclosure, the quality of optical transmission can be improved.

The contents of an embodiment of the present disclosure will be described.
(1) An optical connection assembly of an embodiment of the present disclosure includes: a first optical fiber assembly including a first fiber end face and a plurality of first cores extending from the first fiber end face; a second optical fiber assembly including a second fiber end face facing the first fiber end face and a plurality of second cores extending from the second fiber end face and optically coupling to the plurality of first cores; a first lens including a first lens rear face facing the first fiber end face and a first lens front face facing away from the first lens rear face, the first lens being disposed between the first fiber end face and the second fiber end face; and a second lens including a second lens rear face facing the second fiber end face and a second lens front face facing away from the second lens rear face, the second lens being disposed between the first lens front face and the second fiber end face. Each of the first fiber end face and the first lens rear face is inclined with respect to a plane perpendicular to a central axis of the first lens. Each of the second fiber end face and the second lens rear face is inclined with respect to a plane perpendicular to a central axis of the second lens. The first lens is a lens in which at least one of the first lens rear face and the first lens front face is a curved face. The second lens is a GRIN lens in which each of the second lens rear face and the second lens front face is a flat face.

In the optical connection assembly described above, the second lens that is a GRIN lens is disposed between the first fiber end face of the first optical fiber assembly and the second fiber end face of the second optical fiber assembly. In a case where one first core of the first fiber end face or one second core of the second fiber end face is an emission core from which emission light is emitted, a part of the emission light emitted from the emission core and incident on the second lens is reflected on the second lens rear face or the second lens front face of the second lens as reflected light. In the optical connection assembly described above, since the second lens is a GRIN lens, the second lens has a refractive index distribution for lens action in the plane perpendicular to the central axis of the second lens. Therefore, each of the second lens rear face and the second lens front face of the second lens is not a curved face but a flat face. In this case, the reflected light reflected on the second lens rear face or the second lens front face reversely follows the path of the emission light in the same beam shape as the emission light before reflection without being diffused, and returns to the first fiber end face or the second fiber end face. As a result, at the first fiber end face or the second fiber end face, the beam diameter of the reflected light is substantially the same as the beam diameter of the emission light. When the path of the emission light and the path of the reflected light completely match, the reflected light returns to the emission core (that is, the first core or the second core) from which the emission light is emitted. In the optical connection assembly described above, the normal line of each of the first fiber end face and the first lens rear face is inclined with respect to the central axis of the first lens, and the normal line of each of the second fiber end face and the second lens rear face is inclined with respect to the central axis of the second lens. In this case, since a deviation occurs between the path of the reflected light and the path of the emission light, the possibility that the reflected light returns to the emission core as return light can be reduced. That is, the influence of the return light on the quality of optical transmission can be reduced. Furthermore, in the optical connection assembly described above, while the second lens is a GRIN lens, the first lens is a lens other than a GRIN lens, that is, a lens in which at least one of the first lens rear face and the first lens front face is a curved face. In order to optically couple the first optical fiber assembly and the second optical fiber assembly with a low loss, it may be required to accurately adjust the focal length of each of the first lens and the second lens. In a case where both the first lens and the second lens are GRIN lenses, the focal length of the GRIN lens may rapidly increase according to the lens length of the GRIN lens. Therefore, for example, in a case where the focal lengths of the first lens and the second lens are adjusted to mutually different values, even if the focal length of the second lens can be accurately adjusted, it may be difficult to accurately adjust the focal length of the first lens. In the optical connection assembly described above, a lens having a curved face is used as the first lens. In this case, unlike the GRIN lens, the focal length of the first lens does not rapidly increase according to the parameter of the first lens, so that the focal length of the first lens can be accurately adjusted while the focal length of the second lens is accurately adjusted. As a result, the first optical fiber assembly and the second optical fiber assembly can be optically coupled to each other with a low loss. Therefore, according to the optical connection assembly described above, the quality of optical transmission can be improved.
(2) In the optical connection assembly described in (1), a second core pitch, which is an interval between two second cores adjacent to each other among the plurality of second cores in the second fiber end face, may be smaller than a first core pitch, which is an interval between two first cores adjacent to each other among the plurality of first cores in the first fiber end face. A mode field diameter of each of the plurality of second cores may be smaller than a mode field diameter of each of the plurality of first cores. A focal length of the second lens may be shorter than a focal length of the first lens. In this case, by matching the ratio between the focal length of the first lens and the focal length of the second lens to each of the ratio between the first core pitch and the second core pitch and the ratio between the mode field diameter of the first core and the mode field diameter of the second core, the first optical fiber assembly and the second optical fiber assembly can be optically coupled to each other with a low loss. In a case where a plano-convex lens is used as the second lens having a shorter focal length than the first lens, the lens length of the second lens is shortened according to the focal length, and as the lens length of the second lens is shortened, the reflected light in the second lens is not sufficiently diffused, and conversely, the reflected light is easily coupled to the first optical fiber assembly or the second optical fiber assembly. Therefore, by using a GRIN lens as the second lens, the possibility that the reflected light returns to the emission core can be further reduced, so that the quality of optical transmission can be further improved.
(3) In the optical connection assembly described in (1) or (2), the first lens rear face may be a flat face inclined with respect to the plane perpendicular to the central axis of the first lens. The first lens front face may be a curved face which is convex away from the first lens rear face. In this case, as compared with a case where both the first lens rear face and the first lens front face are curved faces, the number of curved faces that can diffuse the reflected light can be reduced, so that the possibility that the reflected light reflected on the first lens returns to the emission core as return light can be reduced. Thereby, the quality of optical transmission can be further improved.
(4) In the optical connection assembly described in any one of (1) to (3), the second lens rear face may be an inclined face inclined with respect to the plane perpendicular to the central axis of the second lens. The second lens front face may be a vertical face perpendicular to the central axis of the second lens. In this case, the possibility that the reflected light reflected on the second lens front face returns to the emission core as return light can be reduced, and thus the quality of optical transmission can be further improved.
(5) In the optical connection assembly described in any one of (1) to (4), the first fiber end face and the first lens rear face may be disposed in parallel to each other. The second fiber end face and the second lens rear face may be disposed in parallel to each other. In this case, since a deviation between the path of the reflected light and the path of the emission light can be more reliably generated, the possibility that the reflected light reflected on the second lens returns to the emission core as return light can be more reliably reduced. Thereby, the quality of optical transmission can be further improved.
(6) In the optical connection assembly described in any one of (1) to (5), the central axis of the first lens may coincide with an extension line of a central axis of the first optical fiber assembly. The central axis of the second lens may coincide with an extension line of a central axis of the second optical fiber assembly. In order to reduce the possibility that the return light returns to the emission core, for example, it is conceivable to shift the central axis of each of the first lens and the second lens from the respective extension lines of the central axes of the first optical fiber assembly and the second optical fiber assembly. In the above-described optical connection assembly using a GRIN lens as the second lens, the possibility that the return light returns to the emission core can be reduced as described above even when the central axes are not shifted in this way, so that it is possible to reduce an increase in insertion loss due to the misalignment between the respective central axes of the first lens and the second lens and the respective central axes of the first optical fiber assembly and the second optical fiber assembly.
(7) In the optical connection assembly described in any one of (1) to (6), the first optical fiber assembly may include a multicore fiber including the plurality of first cores or an optical fiber array having a plurality of optical fibers each including a respective one of the plurality of first cores. The second optical fiber assembly may include a multicore fiber including the plurality of second cores or an optical fiber array having a plurality of optical fibers each including a respective one of the plurality of second cores. In such a case, the influence of the return light on the quality of optical transmission tends to be large, and thus the effect described in (1) can be effectively obtained.

### DETAILS OF EMBODIMENTS OF PRESENT DISCLOSURE

In the following, a specific example of an optical connection assembly of an embodiment will be described with reference to the drawings. The present disclosure is not limited to these examples, but is indicated by the claims, and is intended to include all alterations within the scope equivalent to the claims. The same or corresponding elements are denoted by the same reference signs in the description of the drawings, and a repeated description is omitted as appropriate. The drawings may be partially simplified or exaggerated for ease of understanding, and dimensional ratios are not limited to those described in the drawings.

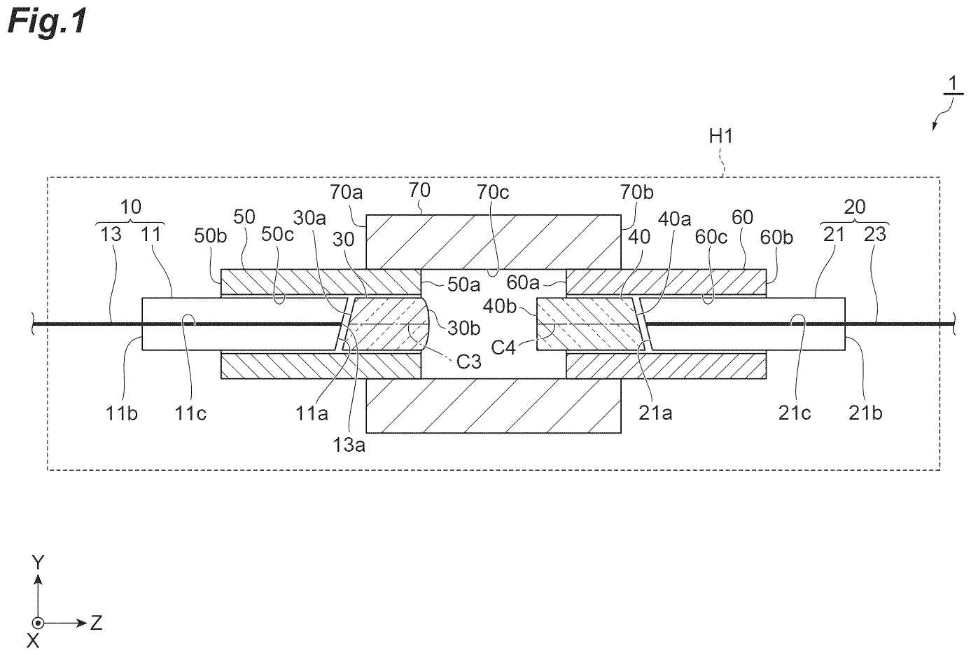

As illustrated in FIG. 1, an optical connection assembly 1 of the present embodiment includes, for example, optical fiber assemblies 10 and 20, lenses 30 and 40, holders 50 and 60, and a sleeve 70. In the present embodiment, the optical fiber assembly 10 is an example of a “first optical fiber assembly” of the present disclosure, and the optical fiber assembly 20 is an example of a “second optical fiber assembly” of the present disclosure. In the present embodiment, the lens 30 is an example of a “first lens” of the present disclosure, and the lens 40 is an example of a “second lens” of the present disclosure.

The optical fiber assembly 10 is disposed at a position facing the optical fiber assembly 20. The lenses 30 and 40 are disposed between the optical fiber assembly 10 and the optical fiber assembly 20. The lenses 30 and 40 are disposed in order from the optical fiber assembly 10 toward the optical fiber assembly 20. The optical fiber assembly 10 is optically coupled to the optical fiber assembly 20 by the lenses 30 and 40.

The optical fiber assembly 10 includes, for example, one capillary 11 and one optical fiber 13. The optical fiber assembly 20 includes, for example, one capillary 21 and one optical fiber 23. In the following description, the direction in which the optical fibers 13 and 23 extend from the optical fiber 13 toward the optical fiber 23 (that is, the direction from left to right in the cross section of FIG. 1) is defined as the positive Z-axis direction, the direction from back to front in the cross section of FIG. 1 in a direction orthogonal to the Z-axis is defined as the positive X-axis direction, and the direction from bottom to top in the cross section of FIG. 1 in a direction orthogonal to the Z-axis and the X-axis is defined as the positive Y-axis direction.

The capillary 11 is a cylindrical member having a central axis extending along the Z-axis. The capillary 11 is formed of, for example, a glass material or a ceramic material. The capillary 11 includes a front end face 11a located at the front end of the capillary 11 in the Z-axis, a rear end face 11b located at the rear end of the capillary 11 in the Z-axis, and a through hole 11c extending along the Z-axis from the front end face 11a to the rear end face 11b.

The front end face 11a is an inclined face inclined with respect to a plane perpendicular to the Z-axis along which the central axis of the capillary 11 extends. In the cross section along the central axis of the capillary 11 (that is, the cross section in FIG. 1), the front end face 11a is inclined with respect to, for example, the Y-axis perpendicular to the central axis of the capillary 11. The angle formed by the normal line of the front end face 11a and the central axis of the capillary 11 is, for example, 2° or more and 10° or less. The rear end face 11b faces a side opposite to the front end face 11a in the Z-axis. The rear end face 11b is a vertical face perpendicular to the Z-axis along which the central axis of the capillary 11 extends. The through hole 11c penetrates the capillary 11 along the Z-axis. The optical fiber 13 is inserted into the through hole 11c. In the present specification, “perpendicular” does not have to be strictly 90°, and may be an angle including a manufacturing error.

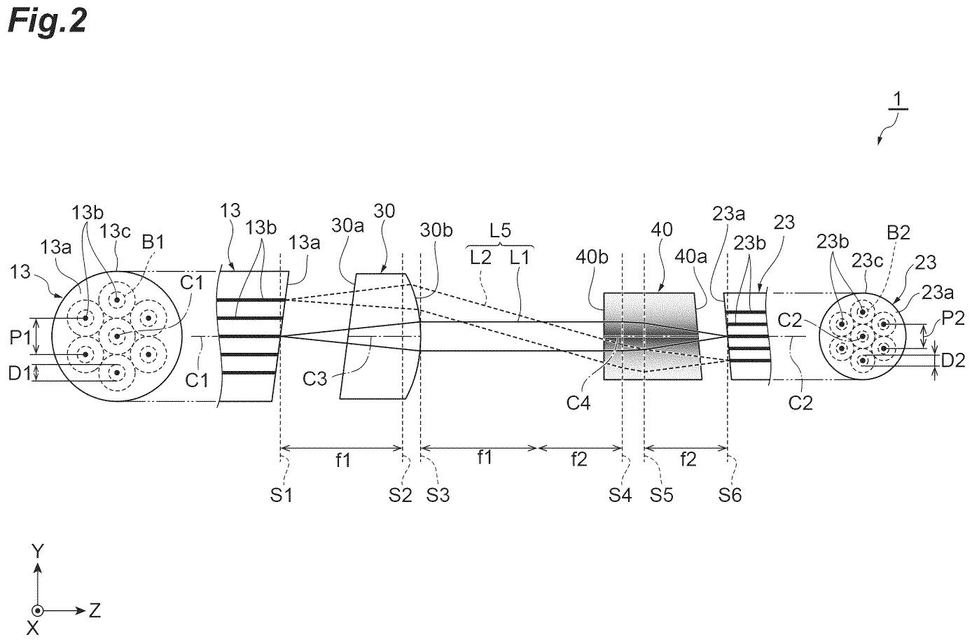

The optical fiber 13 includes a fiber end face 13a located at the front end in the Z-axis. The fiber end face 13a is an example of the “first fiber end face” of the present disclosure. The fiber end face 13a is exposed from an opening of the through hole 11c formed in the front end face 11a of the capillary 11. The fiber end face 13a is an inclined face inclined with respect to a plane perpendicular to the Z-axis along which a central axis C1 (see FIG. 2) of the optical fiber 13 extends. In the cross section of FIG. 1, the inclination direction of the fiber end face 13a coincides with the inclination direction of the front end face 11a of the capillary 11. The fiber end face 13a is formed, for example, by polishing both the optical fiber 13 and the capillary 11.

As illustrated in FIG. 2, the optical fiber 13 is, for example, a multicore fiber. The optical fiber 13 includes a plurality of cores 13b and a cladding 13c surrounding the plurality of cores 13b. In the present embodiment, the plurality of cores 13b are examples of the “plurality of first cores” of the present disclosure.

The plurality of cores 13b extend along the Z-axis along which the central axis C1 of the optical fiber 13 extends. The plurality of cores 13b are exposed from the fiber end face 13a. At least one core 13b among the plurality of cores 13b is disposed at a position shifted from the central axis C1 of the optical fiber 13 on the fiber end face 13a. In the example illustrated in FIG. 2, the plurality of cores 13b include, for example, a central core 13b disposed on the central axis C1 of the optical fiber 13 and peripheral cores 13b arranged along the circumferential direction around the central axis C1 of the optical fiber 13.

Each core 13b has, for example, a rotational symmetry of an even order with respect to the central axis C1 of the optical fiber 13. The respective cores 13b are disposed at positions at equal distances from the central axis C1 of the optical fiber 13 and with an equal core pitch P1 between adjacent cores. The core pitch P1 is an interval between the centers of two cores 13b adjacent to each other among the plurality of cores 13b. In FIG. 2, a dotted line B1 around each core 13b indicates a boundary of a mode field diameter D1 of each core 13b.

The optical fiber 13 is, for example, a TEC (Thermally Expanded Core) fiber. Each core 13b of the optical fiber 13 is enlarged at the fiber end face 13a, for example. As a result, the mode field diameter D1 of each core 13b increases toward the fiber end face 13a. Such cores 13b are formed by performing TEC processing on the end of the optical fiber 13. The TEC processing is a process of expanding each core 13b in a tapered shape by applying heat to the optical fiber 13 to diffuse the dopant.

As illustrated in FIG. 1, the capillary 21 of the optical fiber assembly 20 is disposed at a position facing the capillary 11 of the optical fiber assembly 10 along the Z-axis. The capillary 21 is a cylindrical member having a central axis extending along the Z-axis. The capillary 21 is formed of, for example, a glass material or a ceramic material. The shape of the capillary 21 is, for example, the same as the shape of the capillary 11. The outer diameter of the capillary 21 is the same as the outer diameter of the capillary 11. The capillary 21 includes a front end face 21a located at the front end of the capillary 21 in the Z-axis, a rear end face 21b located at the rear end of the capillary 21 in the Z-axis, and a through hole 21c extending along the Z-axis from the front end face 21a to the rear end face 21b.

The front end face 21a is disposed at a position facing the front end face 11a of the capillary 11 along the Z-axis. The front end face 21a is an inclined face inclined with respect to a plane perpendicular to the Z-axis along which the central axis of the capillary 21 extends. In the cross section along the central axis of the capillary 21 (that is, the cross section in FIG. 1), the front end face 21a is inclined with respect to the Y-axis perpendicular to the central axis of the capillary 21. In the cross section of FIG. 1, the inclination direction of the front end face 21a is different from, for example, the inclination direction of the front end face 11a. The angle formed by the normal line of the front end face 21a and the central axis of the capillary 21 is, for example, the same as the angle formed by the normal line of the front end face 11a and the central axis of the capillary 11.

The rear end face 21b faces a side opposite to the front end face 21a in the Z-axis. The rear end face 21b is a vertical face perpendicular to the Z-axis along which the central axis of the capillary 21 extends. The through hole 21c penetrates the capillary 21 along the Z-axis. The optical fiber 23 is inserted into the through hole 21c.

The optical fiber 23 includes a fiber end face 23a located at the front end in the Z-axis. The fiber end face 23a is an example of the “second fiber end face” of the present disclosure. The fiber end face 23a is disposed at a position facing the fiber end face 13a of the optical fiber 13. The fiber end face 23a is exposed from an opening of the through hole 21c formed in the front end face 21a of the capillary 21. The fiber end face 23a is an inclined face inclined with respect to a plane perpendicular to the Z-axis along which a central axis C2 (see FIG. 2) of the optical fiber 23 extends. In the cross section of FIG. 1, the inclination direction of the fiber end face 23a coincides with the inclination direction of the front end face 21a of the capillary 21. The fiber end face 23a is formed, for example, by polishing the optical fiber 23 and the capillary 21 together.

As illustrated in FIG. 2, the optical fiber 23 is, for example, a multicore fiber. The optical fiber 23 includes a plurality of cores 23b and a cladding 23c surrounding the plurality of cores 23b. In the present embodiment, the plurality of cores 23b are examples of the “plurality of second cores” of the present disclosure.

The plurality of cores 23b extend along the Z-axis along which the central axis C2 of the optical fiber 23 extends. The plurality of cores 23b are exposed from the fiber end face 23a. At least one core 23b among the plurality of cores 23b is disposed at a position shifted from the central axis C2 of the optical fiber 23 on the fiber end face 23a. In the example illustrated in FIG. 2, the plurality of cores 23b include, for example, a central core 23b disposed on the central axis C2 of the optical fiber 23 and peripheral cores 23b disposed to be aligned along the circumferential direction around the central axis C2 of the optical fiber 23.

Each core 23b has, for example, a rotational symmetry of an even order with respect to the central axis C2 of the optical fiber 23. The respective cores 23b are disposed at positions at equal distances from the central axis C2 of the optical fiber 23 and at equal core pitches P2. The core pitch P2 is an interval between the centers of two cores 23b adjacent to each other among the plurality of cores 23b. The core pitch P2 of the optical fiber 23 is smaller than the core pitch P1 of the optical fiber 13.

In FIG. 2, a dotted line B2 around each core 23b indicates a boundary portion of a mode field diameter D2 of each core 23b. The mode field diameter D2 of each core 23b is smaller than the mode field diameter D1 of each core 13b. Therefore, in the optical fibers 13 and 23, relationships of P1>P2 and D1>D2 hold. That is, the cores 23b of the optical fiber 23 are disposed at a higher density than the cores 13b of the optical fiber 13.

The lens 30 is disposed at a position closer to the fiber end face 13a than the fiber end face 23a between the fiber end face 13a of the optical fiber 13 and the fiber end face 23a of the optical fiber 23. The lens 30 faces the fiber end face 13a along the Z-axis. The lens 30 is optically coupled to each core 13b of the optical fiber 13. The lens 30 is, for example, a columnar member having a central axis C3 extending along the Z-axis. The central axis C3 of the lens 30 coincides with, for example, an extension line of the central axis C1 of the optical fiber 13. The outer diameter of the lens 30 is, for example, the same as the outer diameter of the capillary 11. The lens 30 is formed of a material having optical transparency. The material of the lens 30 is, for example, a transparent resin material or a glass material.

The lens 30 includes a lens rear face 30a facing the fiber end face 13a and a lens front face 30b facing a side opposite to the fiber end face 13a. The lens rear face 30a is an example of the “first lens rear face” of the present disclosure. The lens front face 30b is an example of the “first lens front face” of the present disclosure. The lens 30 is, for example, a plano-convex lens. In this case, the lens rear face 30a is, for example, a flat face along the fiber end face 13a, and the lens front face 30b is a curved face which is convex away from the fiber end face 13a. The lens rear face 30a is separated from the fiber end face 13a along the Z-axis. The lens rear face 30a is, for example, an inclined face inclined with respect to a plane perpendicular to the Z-axis along which the central axis C3 of the lens 30 extends. In the cross section of FIG. 1, the inclination direction of the lens rear face 30a coincides with the inclination direction of the fiber end face 13a. That is, the lens rear face 30a is disposed parallel to the fiber end face 13a. In the present specification, “parallel” includes the case of being strictly parallel and the case of being substantially parallel that allows a state including a manufacturing error.

The lens 40 is disposed at a position closer to the fiber end face 23a than the fiber end face 13a between the fiber end face 13a of the optical fiber 13 and the fiber end face 23a of the optical fiber 23. The lens 40 is disposed between the fiber end face 23a and the lens front face 30b. The lens 40 faces the fiber end face 23a and the lens front face 30b along the Z-axis. The lens 40 is optically coupled to each core 23b of the optical fiber 23 and the lens 30.

The lens 40 is, for example, a columnar member having a central axis C4 extending along the Z-axis. The central axis C4 of the lens 40 coincides with, for example, an extension line of the central axis C2 of the optical fiber 23. The outer diameter of the lens 40 is, for example, the same as the outer diameter of the capillary 21. The central axis C4 of the lens 40 coincides with, for example, an extension line of the central axis C3 of the lens 30. Therefore, the central axis C1 of the optical fiber 13, the central axis C3 of the lens 30, the central axis C4 of the lens 40, and the central axis C2 of the optical fiber 23 are located on one straight line. The outer diameter of the lens 40 is, for example, the same as the outer diameter of the lens 30. The lens 40 is formed of, for example, a material having optical transparency. The material of the lens 40 is, for example, a transparent resin material or a glass material.

The lens 40 includes a lens rear face 40a facing the fiber end face 23a and a lens front face 40b facing away from the lens rear face 40a. The lens rear face 40a is an example of the “second lens rear face” of the present disclosure. The lens front face 40b is an example of the “second lens front face” of the present disclosure. The lens 40 is, for example, a GRIN lens. In this case, the lens 40 has a refractive index distribution for lens action in a cross section perpendicular to the central axis C4. The refractive index distribution for lens action is, for example, a distribution in which the refractive index gradually decreases from the center toward the outer periphery of the lens 40.

Each of the lens rear face 40a and the lens front face 40b is not a curved face but a flat face. The lens front face 40b is, for example, a vertical face perpendicular to the Z-axis along which the central axis C4 extends. The lens rear face 40a is, for example, an inclined face inclined with respect to a plane perpendicular to the Z-axis along which the central axis C4 of the lens 40 extends. The lens rear face 40a extends, for example, along the fiber end face 23a. In the cross section of FIG. 1, the inclination direction of the lens rear face 40a coincides with the inclination direction of the fiber end face 23a. That is, the lens rear face 40a is disposed parallel to the fiber end face 23a.

As illustrated in FIG. 2, in a case where light L5 is emitted from the plurality of cores 13b of the optical fiber 13, the light L5 is incident on the lens rear face 30a and then collimated inside the lens 30. The collimated light L5 is emitted from the lens front face 30b and is incident on the lens 40 from the lens front face 40b. The light L5 is condensed by the lens 40 and is incident on the plurality of cores 23b of the optical fiber 23.

In a case where the light L5 is emitted from the plurality of cores 23b of the optical fiber 23, the light L5 is incident on the lens rear face 40a and then collimated inside the lens 40. The collimated light L5 is emitted from the lens front face 40b and is incident on the lens 30 from the lens front face 30b. The light L5 is condensed by the lens 30 and is incident on the plurality of cores 13b of the optical fiber 13. In this manner, the optical fiber 13 is optically coupled to the optical fiber 23 by the lenses 30 and 40. Each of the plurality of cores 13b exposed from the fiber end face 13a is optically coupled to the corresponding core 23b among the plurality of cores 23b exposed from the fiber end face 23a.

The movement of the light L5 between the optical fibers 13 and 23 will be described in more detail with reference to FIG. 2. In FIG. 2, the propagation of the light L5 is depicted geometrically for convenience. The same applies to FIG. 2 and subsequent drawings. The light L5 includes light L1 passing through the central axes C1 and C2 of the optical fibers 13 and 23 and light L2 passing through positions away from the central axes C1 and C2. The light L1 is emitted from the central core 13b of the optical fiber 13 or the central core 23b of the optical fiber 23. The light L2 is emitted from the peripheral cores 13b of the optical fiber 13 or the peripheral cores 23b of the optical fiber 23.

In a case where the light beams L1 and L2 are emitted from the optical fiber 13, the light L1 is emitted from the central core 13b of the optical fiber 13, travels straight along the central axis C1, and is incident on the lens 30 from the lens rear face 30a. The light L1 travels straight inside the lens 30 along the central axis C3 of the lens 30, and is emitted from the lens front face 30b toward the lens 40. The light L1 passing through the central axis C3 is emitted from the lens front face 30b without being bent by the lens front face 30b that is a curved face, and travels straight along the Z-axis toward the lens front face 40b.

The light L1 emitted from the lens front face 30b is incident on the lens 40 from the lens front face 40b, and travels straight inside the lens 40 along the central axis C4 of the lens 40. The light L1 passing through the central axis C4 is condensed along the central axis C4 inside the lens 40 that is a GRIN lens. The condensed light L1 is emitted from the lens rear face 40a, travels straight along the Z-axis, and is incident on the central core 23b of the optical fiber 23 at the fiber end face 23a.

The light L2 is emitted from the peripheral cores 13b of the optical fiber 13, travels straight along the Z-axis, and is incident on the lens 30 from the lens rear face 30a. The light L2 travels straight inside the lens 30 at a position away from the central axis C3 of the lens 30, and is emitted from the lens front face 30b toward the lens 40. The light L2 passing through a position away from the central axis C3 is emitted from the lens front face 30b while being bent by the curved lens front face 30b. The light L2 bent by the lens front face 30b travels straight in a direction inclined with respect to the Z-axis toward the lens front face 40b. Specifically, the light L2 emitted from the lens front face 30b travels so as to intersect the extension line of the central axis C3 of the lens 30. As a result, between the lens front face 30b and the lens front face 40b, the light L2 intersects the light L1 traveling straight along the central axis C3 of the lens 30.

The light L2 emitted from the lens front face 30b travels along a direction inclined with respect to the Z-axis, and is incident on the lens front face 40b at a position away from the central axis C4 of the lens 40. Since the light L2 is away from the central axis C4, the light L2 is condensed while being deflected inside the lens 40. That is, inside the lens 40, the light L2 is condensed while being gradually bent toward the central axis C4 by the lens action of the lens 40. The condensed light L2 is emitted from the lens rear face 40a, travels straight along the Z-axis, and is incident on the peripheral cores 23b of the optical fiber 23 at the fiber end face 23a.

In a case where the light beams L1 and L2 are emitted from the optical fiber 23, the light L1 is emitted from the central core 23b of the optical fiber 23, travels straight along the central axis C2, and is incident on the lens 40 from the lens rear face 40a. The light L1 incident on the lens 40 travels straight inside the lens 40 along the central axis C4 of the lens 40. The light L1 passing through the central axis C4 is collimated without being deflected inside the lens 40. The collimated light L1 is emitted from the lens front face 40b and travels straight along the Z-axis toward the lens 30.

The light L2 is emitted from the peripheral cores 23b of the optical fiber 23, travels straight along the Z-axis, and is incident on the lens 40 from the lens rear face 40a. Since the light L2 is away from the central axis C4 of the lens 40, the light L2 is collimated while being deflected inside the lens 40. That is, inside the lens 40, the light L2 is collimated while being gradually bent toward the central axis C4 by the lens action of the lens 40. The collimated light L2 is emitted from the lens front face 40b and travels straight in a direction inclined with respect to the Z-axis toward the lens front face 30b. Specifically, the light L2 emitted from the lens front face 40b travels so as to intersect the extension line of the central axis C4 of the lens 40. As a result, between the lens front face 40b and the lens front face 30b, the light L2 intersects the light L1 traveling straight along the central axis C4 of the lens 40.

The light L2 emitted from the lens front face 40b travels along a direction inclined with respect to the Z-axis, and is incident on the lens front face 30b at a position away from the central axis C3 of the lens 30. As a result of being bent by the curved lens front face 30b, the light L2 travels straight through the lens 30 along the Z-axis and is condensed. The condensed light L2 is emitted from the lens rear face 30a, travels straight along the Z-axis, and is incident on the peripheral cores 13b of the optical fiber 13 at the fiber end face 13a.

Referring again to FIG. 1. The holder 50 holds the optical fiber assembly 10 and the lens 30. The holder 50 is, for example, a tubular member having a central axis extending along the Z-axis. The holder 50 includes a front end face 50a located at the front end of the holder 50 in the Z-axis, a rear end face 50b located at the rear end of the holder 50 in the Z-axis, and a through hole 50c extending along the Z-axis from the front end face 50a to the rear end face 50b.

The through hole 50c accommodates the optical fiber assembly 10 and the lens 30. In the through hole 50c, the optical fiber assembly 10 is disposed at a position closer to the rear end face 50b than the front end face 50a, and the lens 30 is disposed at a position closer to the front end face 50a than the rear end face 50b. A rear end portion of the optical fiber assembly 10 including the rear end face 11b protrudes from the opening of the through hole 50c formed in the rear end face 50b. A front end portion of the lens 30 including the lens front face 30b protrudes from an opening of the through hole 50c formed in the front end face 50a.

The optical fiber assembly 10 and the lens 30 are fixed to the holder 50 while being accommodated in the through hole 50c. The lens 30 is disposed at a position close to the optical fiber assembly 10 in the through hole 50c. The lens 30 is separated from the optical fiber assembly 10, and a gap (void) is formed between the lens rear face 30a and the fiber end face 13a. As described above, the light L5 emitted from the fiber end face 13a is collimated by the lens 30. That is, the optical fiber assembly 10 and the lens 30 form the collimated light L5. The holder 50 may be called a collimator holder.

The holder 60 holds the optical fiber assembly 20 and the lens 40. The holder 60 is, for example, a tubular member having a central axis extending along the Z-axis. The holder 60 includes a front end face 60a located at the front end of the holder 60 in the Z-axis, a rear end face 60b located at the rear end of the holder 60 in the Z-axis, and a through hole 60c extending along the Z-axis from the front end face 60a to the rear end face 60b.

The through hole 60c accommodates the optical fiber assembly 20 and the lens 40. In the through hole 60c, the optical fiber assembly 20 is disposed at a position closer to the rear end face 60b than the front end face 60a, and the lens 40 is disposed at a position closer to the front end face 60a than the rear end face 60b. A rear end portion of the optical fiber assembly 20 including the rear end face 21b protrudes from the opening of the through hole 60c formed in the rear end face 60b. A front end portion of the lens 40 including the lens front face 40b protrudes from an opening of the through hole 60c formed in the front end face 60a.

The optical fiber assembly 20 and the lens 40 are fixed to the holder 60 while being accommodated in the through hole 60c. The lens 40 is disposed at a position close to the optical fiber assembly 20 in the through hole 60c. The lens 40 is separated from the optical fiber assembly 20, and a gap (void) is formed between the lens rear face 40a and the fiber end face 23a. As described above, the light L5 emitted from the fiber end face 23a is collimated by the lens 40. That is, the optical fiber assembly 20 and the lens 40 form the collimated light L5. The holder 60 may be called a collimator holder.

The sleeve 70 holds the holders 50 and 60. The sleeve 70 is, for example, a tubular member having a central axis extending along the Z-axis. The sleeve 70 includes a first end face 70a located at a first end of the sleeve 70 in the Z-axis, a second end face 70b located at a second end of the sleeve 70 in the Z-axis, and a through hole 70c extending along the Z-axis from the first end face 70a to the second end face 70b.

The through hole 70c accommodates the holders 50 and 60. A front end portion of the holder 50 including the front end face 50a is inserted into an opening of the through hole 70c in the first end face 70a. A front end portion of the holder 60 including the front end face 60a is inserted into an opening of the through hole 70c in the second end face 70b. In the through hole 70c, the front end face 50a of the holder 50 faces the front end face 60a of the holder 60 with a space therebetween. In the through hole 70c, the lens front face 30b of the lens 30 held by the holder 50 faces the lens front face 40b of the lens 40 held by the holder 60 with a space therebetween.

When the optical connection assembly 1 described above is manufactured, first, the optical fiber assembly 10, the optical fiber assembly 20, the lens 30, and the lens 40 are provided.

Next, the optical fiber assembly 10 and the lens 30 are disposed in the through hole 50c of the holder 50. For example, the optical fiber assembly 10 and the lens 30 are fixed to the holder 50 by an adhesive. The optical fiber assembly 20 and the lens 40 are disposed in the through hole 60c of the holder 60. For example, the optical fiber assembly 20 and the lens 40 are fixed to the holder 60 by an adhesive.

Next, the holders 50 and 60 are disposed in the through hole 70c of the sleeve 70. For example, the holders 50 and 60 are fixed to the sleeve 70 by an adhesive. When the holders 50 and 60 are fixed to the sleeve 70, the optical fiber 13 and the optical fiber 23 are aligned so that each core 13b and each core 23b are optically coupled to each other with a low loss. Next, for example, the holder 50, the holder 60, and the sleeve 70 are entirely accommodated and sealed in a cylindrical housing H1. Through the above process, the optical connection assembly 1 in which the lenses 30 and 40 are sequentially arranged from the optical fiber assembly 10 toward the optical fiber assembly 20 between the optical fiber assemblies 10 and 20 can be obtained.

With reference to FIG. 2 again, the arrangement relationship among the optical fiber 13, the lens 30, the lens 40, and the optical fiber 23 will be described in more detail. In FIG. 2, imaginary planes S1, S2, S3, S4, S5, and S6 are illustrated in order to describe the arrangement relationship. The imaginary planes S1, S2, S3, S4, S5, and S6 are arranged in order from the optical fiber 13 toward the optical fiber 23.

The imaginary plane S1 is a plane including an intersection of the central axis C1 of the optical fiber 13 and the fiber end face 13a and is perpendicular to the Z-axis. The imaginary planes S2 and S3 are planes respectively passing through two principal surfaces of the lens 30. The lens 30 is a plano-convex lens having the lens rear face 30a and the lens front face 30b that are asymmetric with respect to each other. In this case, the position of the principal surface of the lens 30 changes depending on the incident direction of the light L5. As a result, the lens 30 has two principal surfaces disposed at mutually different positions in the Z-axis. In the present specification, the “principal surface” is a surface connecting intersections where, in a case where a light beam parallel to the optical axis of the lens is incident, an extension line of a light beam of incident light having an arbitrary height and an extension line of a light beam of an exiting light corresponding to the light beam of the incident light intersect with each other. The imaginary plane S2 passes through the principal surface of the lens 30 disposed at a position close to the optical fiber 13. The imaginary plane S3 passes through the principal surface of the lens 30 disposed at a position close to the lens 40.

The imaginary planes S4 and S5 are planes respectively passing through two principal surfaces of the lens 40. The lens 40 is a GRIN lens and has two principal surfaces disposed at mutually different positions in the Z-axis. The imaginary plane S4 passes through the principal surface of the lens 40 disposed at a position close to the lens 30. The imaginary plane S5 passes through the principal surface of the lens 40 disposed at a position close to the optical fiber 23. The imaginary plane S6 is a plane including an intersection of the central axis C2 of the optical fiber 23 and the fiber end face 23a and is perpendicular to the Z-axis.

The lenses 30 and 40 are arranged between the optical fibers 13 and 23 such that the distance between the imaginary plane S1 and the imaginary plane S2 is equal to the focal length f1 of the lens 30, the distance between the imaginary plane S5 and the imaginary plane S6 is equal to the focal length f2 of the lens 40, and the distance between the imaginary plane S3 and the imaginary plane S4 is equal to the sum of the focal length f1 of the lens 30 and the focal length f2 of the lens 40. In a case where the optical fibers 13 and 23 and the lenses 30 and 40 are arranged in this manner, each core 13b of the optical fiber 13 can be optically coupled to a corresponding core 23b of the optical fiber 23 with a low loss of, for example, less than 1 dB.

In the present embodiment, the core pitch P1 of the optical fiber 13, the core pitch P2 of the optical fiber 23, the mode field diameter D1 of each core 13b of the optical fiber 13, the mode field diameter D2 of each core 23b of the optical fiber 23, the focal length f1 of the lens 30, and the focal length f2 of the lens 40 satisfy the following Equation (1). That is, each of the ratio between the core pitch P1 of the optical fiber 13 and the core pitch P2 of the optical fiber 23 and the ratio between the mode field diameter D1 of the optical fiber 13 and the mode field diameter D2 of the optical fiber 23 coincides with the ratio between the focal length f1 of the lens 30 and the focal length f2 of the lens 40.

D1/D2=P1/P2=f1/f2 (1)

In a case where Equation (1) is satisfied, the core arrangement of the optical fiber 13 is similar to the core arrangement of the optical fiber 23. The core arrangement of the optical fiber 13 is the arrangement of the plurality of cores 13b on the fiber end face 13a. The core arrangement of the optical fiber 23 is the arrangement of the plurality of cores 23b on the fiber end face 23a. In a case where the core arrangement of the optical fiber 13 is similar to the core arrangement of the optical fiber 23, the light distribution formed on the fiber end face 13a becomes a similar distribution enlarged or reduced by the ratio between the focal lengths f1 and f2 on the fiber end face 23a. In this case, the mode field diameter and the center position in the light distribution formed on the fiber end face 13a are transformed by the lenses to match the mode field diameter and the center position of the corresponding cores on the fiber end face 23a, respectively. Therefore, in a case where the optical fibers 13 and 23 and the lenses 30 and 40 are arranged so as to satisfy Equation (1), each core 13b of the optical fiber 13 can be optically coupled to each core 23b of the optical fiber 23 with a low loss of, for example, less than 1 dB.

In the present embodiment, the core pitch P2 of the optical fiber 23 is smaller than the core pitch P1 of the optical fiber 13, and the mode field diameter D2 of each core 23b of the optical fiber 23 is smaller than the mode field diameter D1 of each core 13b of the optical fiber 13. That is, in the optical fibers 13 and 23, relations of P1>P2 and D1>D2 are established. In this case, in order to satisfy Equation (1), the ratio (f1/f2) between the focal length f1 of the lens 30 and the focal length f2 of the lens 40 needs to coincide with each of the ratio (P1/P2) between the core pitch P1 of the optical fiber 13 and the core pitch P2 of the optical fiber 23 and the ratio (D1/D2) between the mode field diameter D1 of each core 13b of the optical fiber 13 and the mode field diameter D2 of each core 23b of the optical fiber 23. Therefore, in the present embodiment, the focal length f2 of the lens 40 is set to be shorter than the focal length f1 of the lens 30. That is, in the lenses 30 and 40, a relationship of f1>f2 is established.

In the present embodiment, a combination of a plano-convex lens and a GRIN lens is adopted as a combination of the lens 30 and the lens 40. The reason for adopting the combination of a plano-convex lens and a GRIN lens will be described with reference to the problems of the conventional technique.

First, as a background art, in order to cope with an increase in communication capacity in recent optical communication, not only wavelength division multiplexing (WDM) in which a plurality of optical signals having mutually different wavelengths are simultaneously transmitted, but also space division multiplexing (SDM) in which a plurality of optical signals are spatially simultaneously transmitted using an optical fiber array having a plurality of optical waveguides is used. In the case of using the space division multiplexing, there is a need for a conversion device that connects members (for example, optical fiber arrays, multicore fibers, or a multicore fiber and an optical fiber array) having a plurality of optical waveguides to each other.

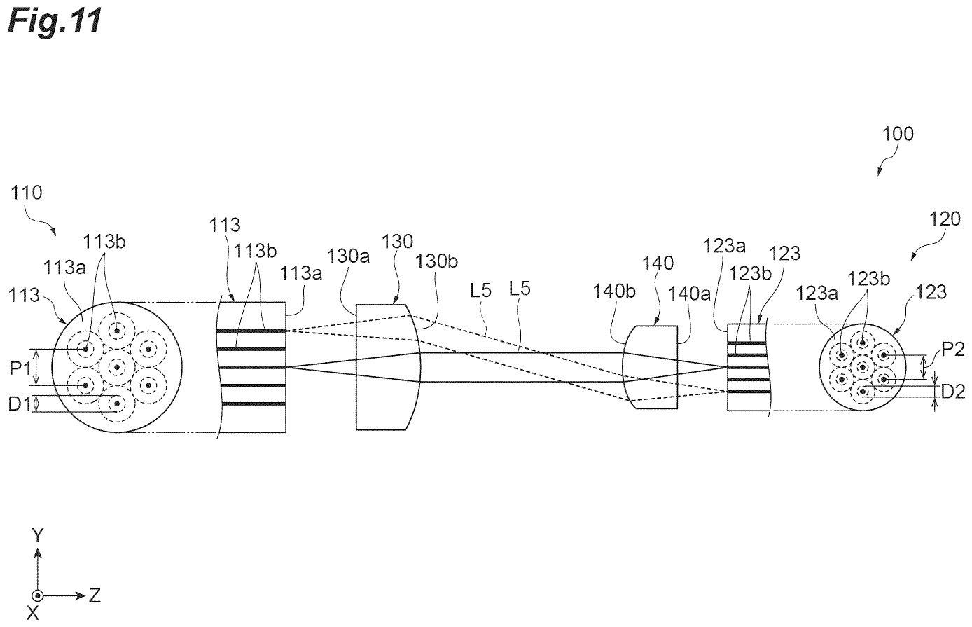

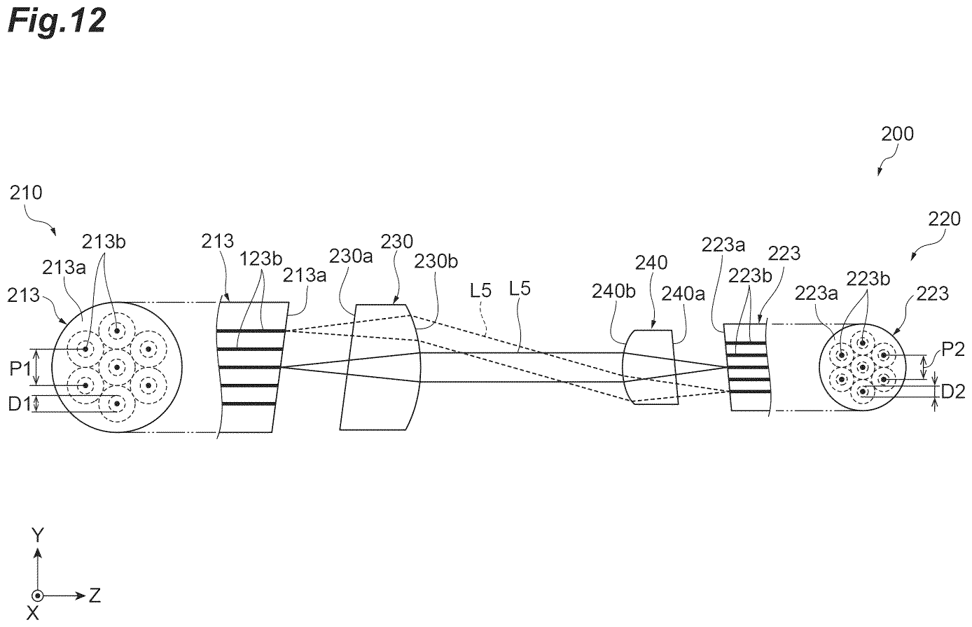

A conversion device that connects a multicore fiber and an optical fiber array is called a fan-in fan-out (FIFO), and is attracting attention as an essential device for introducing a multicore fiber into a system including a conventional optical fiber having a single core. Such a conversion device includes a type in which optical fibers are directly coupled to each other by physical contact, and a type in which optical fibers are spatially coupled to each other through a lens. Conventionally, an optical connection assembly illustrated in FIGS. 11 and 12 is known as an optical connection assembly including a conversion device of a type in which optical fibers are spatially coupled to each other through a lens.

An optical connection assembly 100 illustrated in FIG. 11 includes an optical fiber assembly 110, an optical fiber assembly 120, a lens 130, and a lens 140. The optical fiber assembly 110 has an optical fiber 113 including a plurality of cores 113b extending from a fiber end face 113a. The optical fiber assembly 120 has an optical fiber 123 including a plurality of cores 123b extending from a fiber end face 123a. The mode field diameter D2 and the core pitch P2 of the optical fiber 123 are smaller than the mode field diameter D1 and the core pitch P1 of the optical fiber 113, respectively. Each of the optical fibers 113 and 123 is not necessarily a multicore fiber. At least one of the optical fibers 113 and 123 may be an optical fiber array.

The lens 130 is disposed at a position close to the optical fiber assembly 110 between the optical fiber assemblies 110 and 120. The lens 130 is a plano-convex lens having a flat face 130a facing the fiber end face 113a of the optical fiber assembly 110 and a curved face 130b facing a side opposite to the flat face 130a. The lens 140 is disposed at a position close to the optical fiber assembly 120 between the optical fiber assemblies 110 and 120. The lens 140 is a plano-convex lens having a flat face 140a facing the fiber end face 123a of the optical fiber assembly 120 and a curved face 140b facing a side opposite to the flat face 140a.

In the optical connection assembly 100, the fiber end face 113a and the flat face 130a facing each other are perpendicular to the Z-axis in which the central axis of each of the optical fiber 113 and the lens 130 extends. Similarly, the fiber end face 123a and the flat face 140a facing each other are perpendicular to the Z-axis in which the central axis of each of the optical fiber 123 and the lens 140 extends. In this case, for example, a part of the light L5 (for example, light of about −15 dB) emitted from the core 113b of the optical fiber 113 is reflected on the fiber end face 113a, is coupled to the core 113b. which is the emission source, and returns in the opposite direction. In a case where a part of the light L5 returns to the core 113b, which is the emission source, as return light, there is a possibility that the operation of a device (for example, an amplifier and a laser) that can be disposed upstream of the optical fiber 113 becomes unstable. A similar phenomenon also occurs when the light L5 is emitted from the core 123b of the optical fiber 123.

In order to reduce the influence of such return light, an optical connection assembly 200 illustrated in FIG. 12 is known. The optical connection assembly 200 includes an optical fiber assembly 210, an optical fiber assembly 220, and lenses 230 and 240. The lenses 230 and 240 are plano-convex lenses like the lenses 130 and 140. In the optical connection assembly 200, a fiber end face 213a of an optical fiber 213 of the optical fiber assembly 210 is inclined from a plane perpendicular to a central axis of the optical fiber 213. Similarly, a fiber end face 223a of an optical fiber 223 of the optical fiber assembly 220 is inclined from a plane perpendicular to a central axis of the optical fiber 223.

As the fiber end faces 213a and 223a are inclined in this manner, the influence of the return light described above can be reduced. Furthermore, in a case where an anti-reflection (AR) film is formed on the fiber end faces 213a and 223a by vapor deposition, the influence of the return light described above can be reduced to a negligible level. For example, in an optical fiber for 1550 nm, in a case where the fiber end face of the optical fiber is inclined by 8°, the reflection can be reduced to −65 dB even in a state where the AR film is not formed on the fiber end face. In this optical fiber, in a case where the fiber end face is inclined by 4°, the reflection can be reduced to −35 dB in a state where the AR film is not formed on the fiber end face; however, in a case where the AR film having a reflectance of 0.25% is formed on the fiber end face, the reflection can be reduced to −61 dB.

Furthermore, in the optical connection assembly 200, a flat face 230a of the lens 230 is inclined along the fiber end face 213a, and a flat face 240a of the lens 240 is inclined along the fiber end face 223a. As described above, by inclining the flat faces 230a and 240a close to the fiber end faces 213a and 223a, respectively, it is possible to further reduce the possibility that a part of the light L5 reflected on the flat faces 230a and 240a returns to the fiber end faces 213a and 223a, respectively.

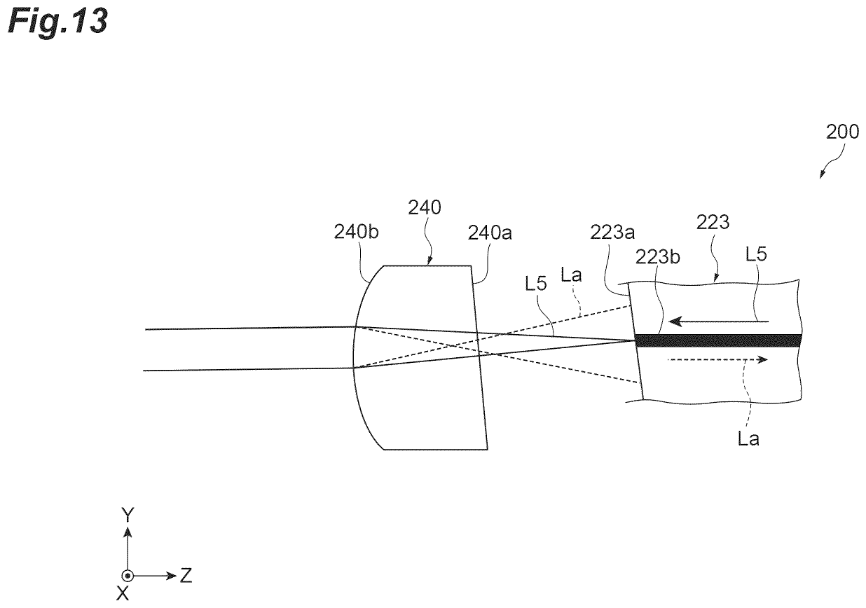

However, in the optical connection assembly 200, in addition to reflection on the fiber end faces 213a and 223a and the flat faces 230a and 240a, reflection also occurs on curved faces 230b and 240b having a lens effect. As illustrated in FIG. 13, out of the light beams L5 emitted from the core 223b of the optical fiber 223 and incident on the lens 240, light La reflected on the curved face 240b of the lens 240 is condensed in front of the optical fiber 223 and then diffused. Since the diffused light La is distributed in a wide range on the fiber end face 223a, a part of the light La is coupled to the core 223b, which is an emission source, or the core 223b adjacent thereto as return light.

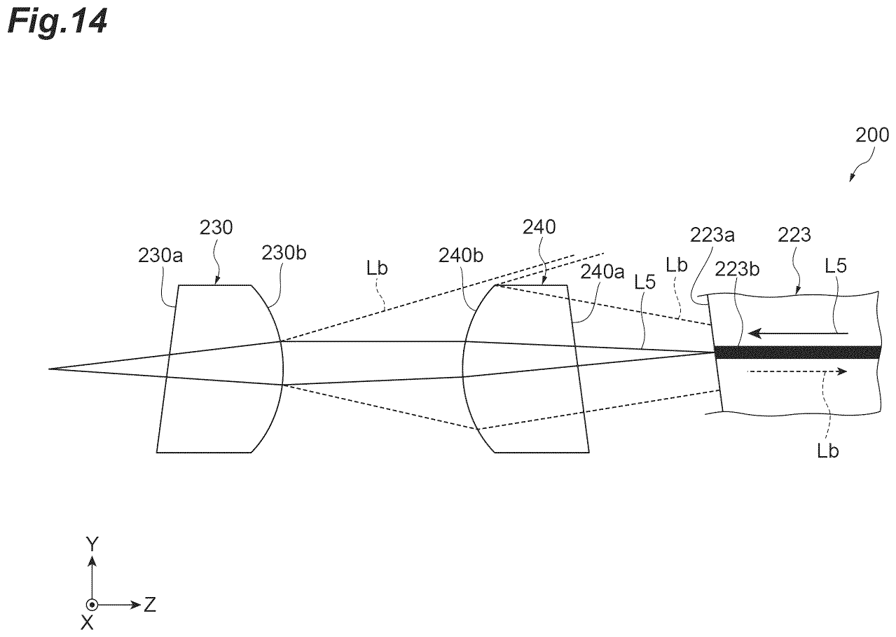

As illustrated in FIG. 14, out of the light beams L5 emitted from the core 223b of the optical fiber 223 and transmitted through the lens 240, light Lb reflected on the curved face 230b of the lens 230 is diffused by the curved face 230b. Since the diffused light Lb is condensed by the curved face 240b of the lens 240 and distributed in a wide range on the fiber end face 223a, a part of the light Lb is coupled to the core 223b, which is an emission source, or the core 223b adjacent thereto as return light.

In a case where a part of the light L5 returns to the optical fiber 223 as return light in this way, the intensity of the return light is minute as compared with the intensity of the original light L5, but there is a possibility that the signal quality of the optical fiber 223 is deteriorated. For example, in a case where a part of the light L5 is coupled to the core 223b, which is an emission source, as return light, if no measure is taken to reduce the return light in a device disposed upstream of the optical fiber 223, the operation of the device may become unstable.

Furthermore, in the optical fiber 223 having a plurality of cores 223b, propagation directions of light beams may be reversed in the cores 223b adjacent to each other. In this case, when a part of the light L5 emitted from the core 223b of an emission source is reflected on the curved face 240b of the lens 240 and is coupled to the core 223b adjacent to the core 223b of an emission source, the return light acts as noise to the signal propagating in the adjacent core, potentially degrading the signal quality of the optical fiber 223.

On the other hand, the present embodiment solves the above-described problems by adopting the combination of a plano-convex lens and a GRIN lens.

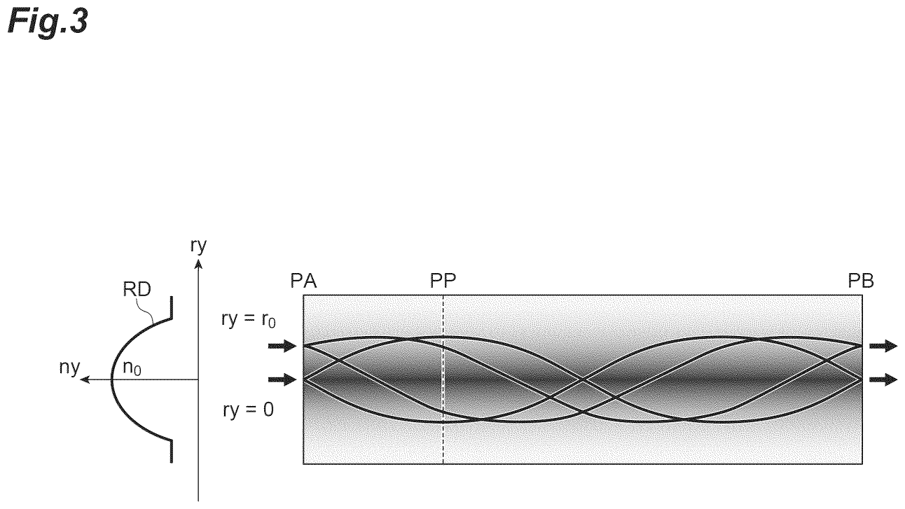

In order to explain the advantage of adopting the combination of a plano-convex lens and a GRIN lens, first, the principle of the GRIN lens will be described. As illustrated in FIG. 3, the GRIN lens is usually a columnar member, and has a refractive index distribution RD in which the refractive index gradually decreases from the center toward the outer periphery. In the refractive index distribution RD, the refractive index of the GRIN lens is uniform in the axial direction of the GRIN lens, but changes in a parabolic shape near the center of the GRIN lens. The parabola of the refractive index distribution RD near the center of the GRIN lens is expressed by the following Equation (2). In Equation (2), “ry” indicates a position from the center of the GRIN lens. “n(ry)” indicates the refractive index at the position ry of the GRIN lens. “n₀” indicates the refractive index at the center of the GRIN lens. “gy” indicates a coefficient of the refractive index distribution RD of the GRIN lens.

n(ry)=n₀(1−gy²ry²/2) (2)

In a case where a beam having a sufficiently narrowed beam diameter is incident at a position r₀ from the center of the GRIN lens, as illustrated in FIG. 3, the beam draws a sinusoidal trajectory due to the influence of the refractive index distribution RD. In a case where a lens length tz of the GRIN lens (that is, the distance from PA to PB in FIG. 3) is equal to a pitch Pz, which is the length defined by the following Equation (3), the converging beams having the same beam diameter are emitted from the same position r₀ regardless of the incident position of the beam on the GRIN lens. In a case where the lens length tz is equal to 0.25 Pz (that is, in a case where the lens length tz is the distance from PA to PP in FIG. 3), the GRIN lens serves as a collimator lens that converts the diverging beam into a non-diverging beam (that is, a parallel beam). Furthermore, the GRIN lens can also mutually convert between a parallel beam and a diffused beam originating from a focal point at a minute distance dz from the lens end face. The relationship among the distance dz, the focal length fz, and the lens length tz is expressed by the following Equations (4) and (5). Therefore, the GRIN lens (that is, the lens 40) illustrated in FIG. 2 can be obtained by selecting the coefficient gy of an appropriate refractive index distribution RD and adjusting the lens length tz.

Pz=21/gy (3)

fz=1/(n₀×gy×sin(gy×tz)) (4)

dz=1/(n₀×gy×tan(gy×tz)) (5)

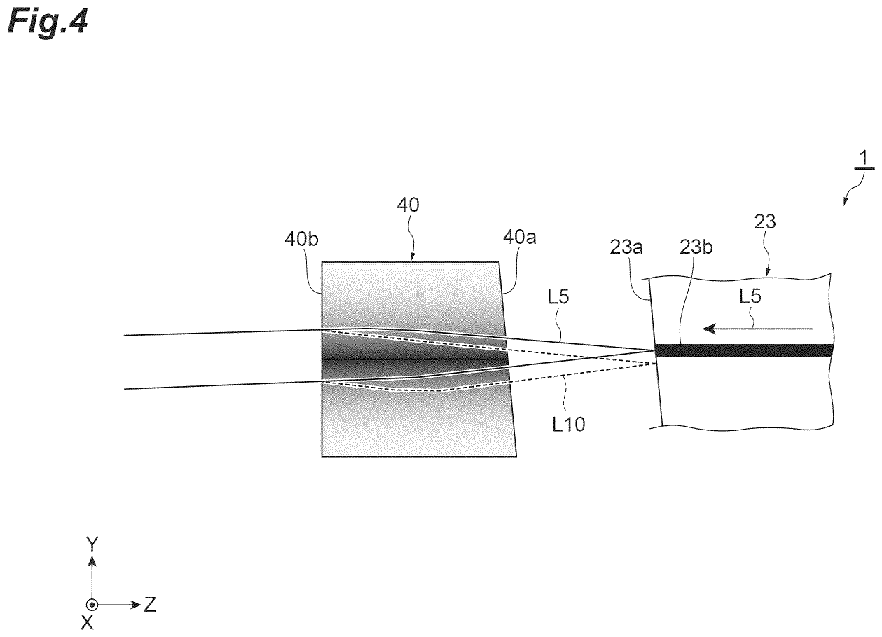

As illustrated in FIG. 4, when the light L5 emitted from the core 23b of the optical fiber 23 is incident on the lens 40 having the above-described refractive index distribution RD, light L10 reflected on the lens front face 40b of the lens 40 out of the light beams L5 incident on the lens 40 is parallel light that is the same as the light L5 before reflection, and consequently, the beam of light L10 retraces the path of the incident light, and at the fiber end face 23a, its beam diameter is substantially the same as the beam diameter of the light L5. When the path of the light L10 after reflection completely coincides with the path of the light L5 before reflection, there is a possibility that the light L10 is coupled to the core 23b of an emission source. However, in a case where the fiber end face 23a and the lens rear face 40a are inclined as in the present embodiment, as illustrated in FIG. 4, the path of the light L10 after reflection is slightly shifted from the path of the light L5 before reflection, so that the possibility that the light L10 returns to the core 23b of an emission source can be reduced. Furthermore, if the deviation between the path of the light L10 after reflection and the path of the light L5 before reflection does not coincide with the distance between the core 23b of an emission source and the core 23b adjacent thereto, the possibility that the light L10 returns to the adjacent core 23b can also be reduced.

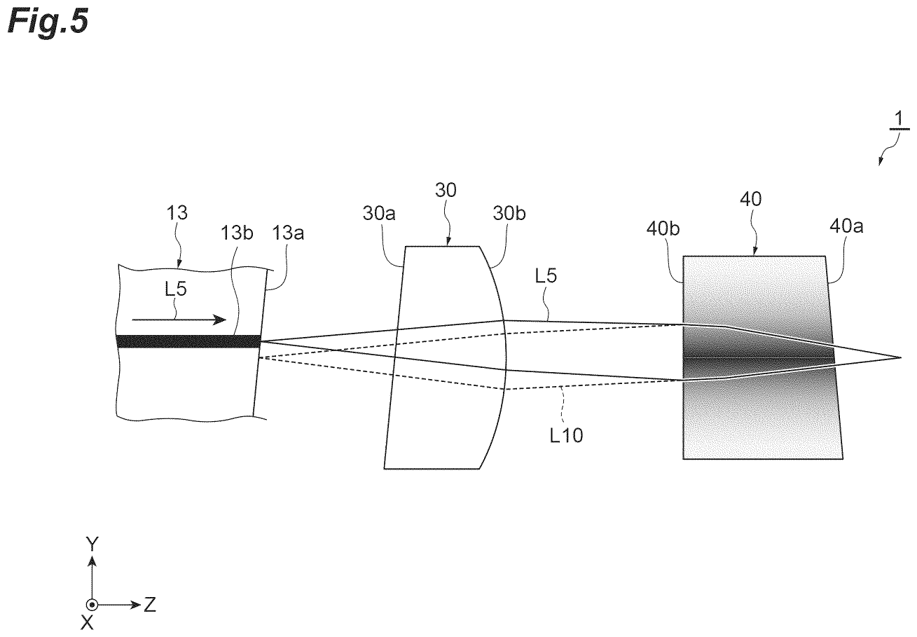

As illustrated in FIG. 5, even when the light L5 is emitted from the core 13b of the optical fiber 13, the possibility that the light L10, which is a portion of the light L5 incident on the lens 40 through the lens 30 and reflected by the lens front face 40b of the lens 40, returns to the emission core 13b and the core 13b adjacent thereto can be reduced based on the same principle. Therefore, when a GRIN lens is used for the lens 40 as in the present embodiment, the possibility that the light L10 reflected by the lens 40 enters the core 13b of the optical fiber 13 as return light is reduced, thereby reducing the possibility that the signal quality is deteriorated due to the influence of the return light.

Next, the reason for using a GRIN lens for only the lens 40 instead of using a GRIN lens for both the lenses 30 and 40 will be described.

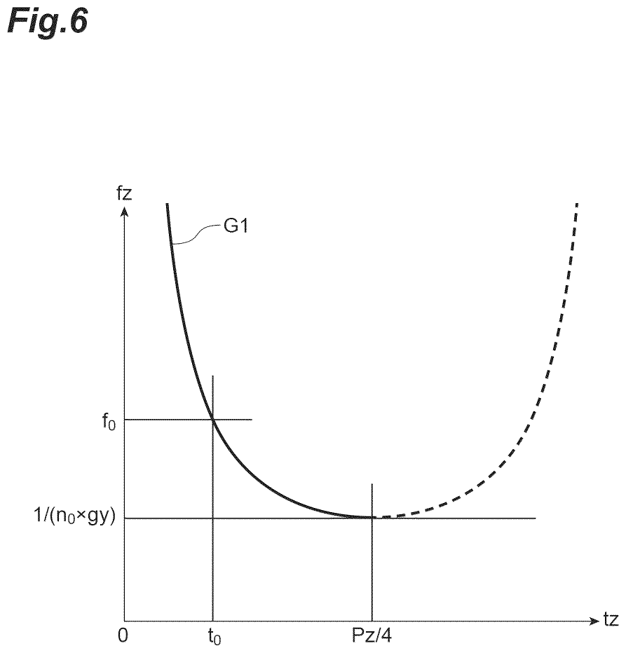

As expressed in Equation (4) described above, the focal length fz of the GRIN lens depends on the coefficient gy regarding the refractive index distribution RD, no indicating the refractive index at the center of the GRIN lens, and the lens length tz. Among these parameters, no is determined by the lens base material, and gy tends to depend on the lens diameter in consideration of the manufacturing method of the GRIN lens. Therefore, since it is difficult to obtain the target focal length fz by adjusting these parameters no and gy, in principle, the focal length fz is adjusted by adjusting the lens length tz. A graph G1 in FIG. 6 shows a relationship between the lens length tz and the focal length fz in the GRIN lens. As shown in the graph G1, the focal length fz of the GRIN lens takes a minimum value (1/(n₀×gy)) when tz=0.25 Pz. Further, when the lens length tz becomes shorter than that minimum value, the focal length fz rapidly increases.

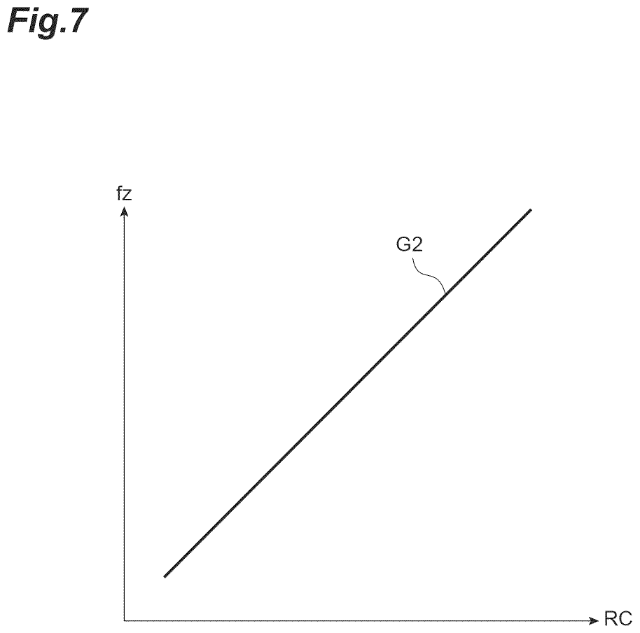

Considering the tolerance of the lens length tz, in a case where the lens length tz is 0.25 Pz or slightly shorter than 0.25 Pz, the influence of the lens length tz on the focal length fz is small. However, in a case where the lens length tz of the GRIN lens is adjusted to t₀ in order to obtain a short GRIN lens having the focal length f₀ greatly away from the minimum value (1/(n₀×gy)), as is apparent from the slope of the characteristic curve of the graph G1, the influence of the tolerance of the lens length tz on the focal length fz becomes extremely large. On the other hand, as expressed in the following Equation (6), the focal length fz of the plano-convex lens depends on the radius of curvature RC of the curved face of the plano-convex lens and a refractive index ny of the plano-convex lens. The refractive index ny is determined by the lens material, but the radius of curvature RC can be adjusted with high accuracy by polishing and molding the curved face of the plano-convex lens. A graph G2 in FIG. 7 shows a relationship between the radius of curvature RC and the focal length fz in the plano-convex lens. As shown in the graph G2, the focal length fz of the plano-convex lens is proportional to the radius of curvature RC, but does not rapidly increase unlike that of the GRIN lens.

fz=RC/(ny−1) (6)

Therefore, if GRIN lenses were used for both the lenses 30 and 40, even if a GRIN lens having a lens length tz of 0.25 Pz or a value slightly shorter than 0.25 Pz were used for one of the lenses 30 and 40, it would be necessary to use a GRIN lens having a short lens length tz greatly away from 0.25 Pz for the other lens in order to satisfy the relationship of Equation (1) described above. In this case, the focal length fz of the GRIN lens having a short lens length tz is likely to deviate significantly depending on the tolerance of the lens length tz. Accordingly, since the ratio of f1/f2 expressed by Equation (1) is also likely to deviate, it is difficult to maintain optical coupling with a low loss (for example, less than 1 dB) between the optical fibers 13 and 23.

On the other hand, in the present embodiment, a GRIN lens is adopted for the lens 40, and a plano-convex lens is adopted for the lens 30. In this case, by using a GRIN lens having a lens length tz of 0.25 Pz or a slightly shorter value than 0.25 Pz as the lens 40, the possibility that the focal length fz of the lens 40 greatly deviates according to the tolerance of the lens length tz can be reduced. Further, even when the focal length fz of the lens 30 that is a plano-convex lens is adjusted in order to satisfy the relationship of Equation (1), the focal length fz of the plano-convex lens does not rapidly increase according to the curvature radius RC as described above, so that the possibility that the ratio (f1/f2) of the focal lengths expressed in Equation (1) is greatly deviated can be reduced. Thus, in the present embodiment in which the combination of a plano-convex lens and a GRIN lens is adopted as the combination of the lenses 30 and 40, it is possible to easily maintain optical coupling with a low loss (for example, less than −1 dB) between the optical fibers 13 and 23 in a state where Equation (1) is satisfied. Therefore, according to the optical connection assembly of the present embodiment, the quality of optical transmission can be improved.

As in the present embodiment, the core pitch P2 of the optical fiber 23 may be smaller than the core pitch P1 of the optical fiber 13. The mode field diameter D2 of each of the plurality of cores 23b may be smaller than the mode field diameter D1 of each of the plurality of cores 13b. The focal length f2 of the lens 40 may be shorter than the focal length f1 of the lens 30. In this case, by matching the ratio (f1/f2) between the focal length f1 of the lens 30 and the focal length f2 of the lens 40 to each of the ratio (P1/P2) between the core pitch P1 and the core pitch P2 and the ratio (D1/D2) between the mode field diameter D1 of the core 13b and the mode field diameter D2 of the core 23b, the optical fiber assembly 10 and the optical fiber assembly 20 can be optically coupled to each other with a low loss. In a case where a plano-convex lens is used as the lens 40 having a shorter focal length f2 than the lens 30, the lens length tz of the lens 40 is shortened according to the focal length f2, and as the lens length tz of the lens 40 is shortened, the reflected light (light L10) in the lens 40 is not sufficiently diffused, and conversely, the reflected light is easily coupled to the optical fibers 13 and 23. That is, in a case where the focal length f1 of the lens 30 and the focal length f2 of the lens 40 are different from each other, it is suitable to adopt a GRIN lens for the lens 40 having the focal length f2 shorter than the focal length f1 of the lens 30 of the lenses 30 and 40. Thereby, the possibility that the reflected light returns to the cores 13b and 23b of emission sources can be further reduced, so that the quality of optical transmission can be further improved.

As in the present embodiment, the lens rear face 30a may be a flat face inclined with respect to a plane perpendicular to the central axis C3 of the lens 30. The lens front face 30b may be a curved face which is a convex toward a side opposite to the lens rear face 30a. In this case, as compared with a case where both the lens rear face 30a and the lens front face 30b are curved faces, since the number of curved faces that can diffuse the reflected light can be reduced, the possibility that the reflected light reflected by the lens 30 returns to the cores 13b and 23b of emission sources as return light can be reduced, thereby further improving the quality of optical transmission can be further improved.

As in the present embodiment, the lens rear face 40a may be an inclined face inclined with respect to a plane perpendicular to the central axis C4 of the lens 40. The lens front face 40b may be a vertical face perpendicular to the central axis C4 of the lens 40. In this case, since the possibility that the reflected light reflected by the lens front face 40b returns to the cores 13b and 23b of emission source as return light can be reduced, the quality of optical transmission can be further improved.

As in the present embodiment, the fiber end face 13a and the lens rear face 30a may be disposed in parallel to each other. The fiber end face 23a and the lens rear face 40a may be disposed in parallel to each other. In this case, since a deviation between the path of the reflected light and the path of the emission light can be more reliably generated, the possibility that the reflected light reflected by the lens 40 returns to the cores 13b and 23b of emission sources as return light can be more reliably reduced. Thereby, the quality of optical transmission can be further improved.

As in the present embodiment, the central axis C3 of the lens 30 may coincide with an extension line of the central axis C1 of the optical fiber assembly 10. The central axis C4 of the lens 40 may coincide with an extension line of the central axis C2 of the optical fiber assembly 20. In order to reduce the possibility that the return light returns to the cores 13b and 23b of emission sources, it is conceivable to shift the central axes C3 and C4 of the lenses 30 and 40 from the respective extension lines of the central axes C1 and C2 of the optical fiber assemblies 10 and 20, respectively. In the optical connection assembly 1 using a GRIN lens as the lens 40, the possibility that the return light returns to the cores 13b and 23b of emission sources can be reduced as described above even when the central axes are not shifted in this way, so that it is possible to reduce an increase in insertion loss due to the misalignment between the respective central axes of the lenses 30 and 40 and the respective central axes of the optical fiber assemblies 10 and 20. As a result, the quality of optical transmission can be further improved.

As in the present embodiment, the optical fiber assembly 10 may include the optical fiber 13 that is a multicore fiber. The optical fiber assembly 20 may include the optical fiber 23 that is a multicore fiber. In such a case, since the influence of the return light on the quality of optical transmission tends to be large, the effect described above can be effectively obtained.

Some modifications of the present embodiment will be described below.

### Modification 1

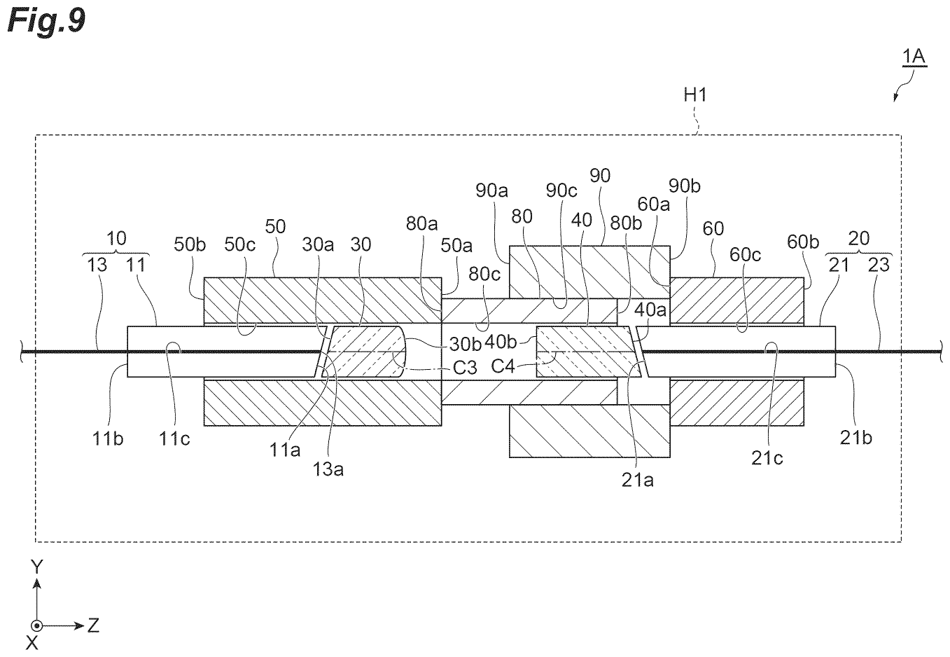

An optical connection assembly 1A illustrated in FIG. 9 includes optical fiber assemblies 10 and 20, lenses 30 and 40, holders 50, 60, and 80, and a sleeve 90. In the optical connection assembly 1A, the holder 60 holds only the optical fiber assembly 20, and not the lens 40. A front end portion of the optical fiber assembly 20 including the front end face 21a protrudes from an opening of the through hole 60c formed in the front end face 60a of the holder 60.

The holder 80 is disposed between the holders 50 and 60 in the Z-axis. For example, the holder 80 is separated from the holder 60 in the Z-axis and is in contact with the holder 50 in the Z-axis. The holder 80 holds the lens 40 facing the optical fiber assembly 20. The holder 80 is, for example, a tubular member having a central axis extending along the Z-axis. The outer diameter of the holder 80 is smaller than the outer diameter of each of the holders 50 and 60. The central axis of the holder 80 is, for example, parallel to the central axis of the holder 60. The central axis of the holder 80 coincides with, for example, an extension line of the central axis of the holder 60. The holder 80 includes a front end face 80a located at the front end of the holder 80 in the Z-axis, a rear end face 80b located at the rear end of the holder 80 in the Z-axis, and a through hole 80c extending along the Z-axis from the front end face 80a to the rear end face 80b.

The rear end face 80b faces the front end face 60a of the holder 60 along the Z-axis. The rear end face 80b is, for example, separated from the front end face 60a in the Z-axis. The front end face 80a faces the front end face 50a of the holder 50 along the Z-axis. The front end face 80a is, for example, in contact with the front end face 50a in the Z-axis, and is connected to the front end face 50a. The through hole 80c accommodates the lens 40. The inner diameter of the through hole 80c is, for example, the same as each of the inner diameter of the through hole 50c of the holder 50 and the inner diameter of the through hole 60c of the holder 60. The through hole 80c is connected to the through hole 50c of the holder 50 at the front end faces 50a and 80a connected to each other.

The lens 40 is fixed to the holder 80 while being accommodated in the through hole 80c. In the through hole 80c, the lens 40 is disposed at a position closer to the rear end face 80b than the front end face 80a. A rear end portion of the lens 40 including the lens rear face 40a protrudes from an opening of the through hole 80c formed in the rear end face 80b. The lens 40 is separated from the optical fiber assembly 20, and a gap (void) is formed between the lens rear face 40a and the fiber end face 23a. The lens front face 40b is separated from the lens front face 30b of the lens 30 held by the holder 50 by a gap in the Z-axis.

The sleeve 90 holds the holder 80. The sleeve 90 is, for example, a tubular member having a central axis extending along the Z-axis. The central axis of the sleeve 90 is, for example, parallel to the central axis of each of the holders 50, 60, and 80. The central axis of the sleeve 90 coincides with, for example, the central axis of the holder 80. The sleeve 90 includes a first end face 90a located at a first end of the sleeve 90 in the Z-axis, a second end face 90b located at a second end of the sleeve 90 in the Z-axis, and a through hole 90c extending along the Z-axis from the first end face 90a to the second end face 90b.

The second end face 90b faces the front end face 60a of the holder 60 along the Z-axis. The second end face 90b is, for example, in contact with the front end face 60a in the Z-axis, and is connected to the front end face 60a. The first end face 90a faces the front end face 50a of the holder 50 along the Z-axis. The first end face 90a is, for example, separated from the front end face 50a in the Z-axis.

The through hole 90c accommodates the holder 80. The inner diameter of the through hole 90c is equal to the outer diameter of the holder 80 or larger than the outer diameter of the holder 80. The inner diameter of the through hole 90c is larger than each of the inner diameter of the through hole 50c of the holder 50 and the inner diameter of the through hole 60c of the holder 60. The through hole 90c is connected to the through hole 60c of the holder 60 in the front end face 60a and the second end face 90b connected to each other. The through hole 90c accommodates the holder 80. A front end portion of the holder 80 including the front end face 80a is inserted into an opening of the through hole 90c in the first end face 90a.

When the optical connection assembly 1A described above is manufactured, first, the optical fiber assemblies 10 and 20, the lenses 30 and 40, the holders 50, 60, and 80, and the sleeve 90 are prepared.

Next, the optical fiber assembly 10 and the lens 30 are disposed in the through hole 50c of the holder 50. For example, the optical fiber assembly 10 and the lens 30 are fixed to the holder 50 by an adhesive. The optical fiber assembly 20 is disposed in the through hole 60c of the holder 60. For example, the optical fiber assembly 20 is fixed to the holder 60 by an adhesive. The lens 40 is disposed in the through hole 80c of the holder 80. For example, the lens 40 is fixed to the holder 80 by an adhesive.

Next, the holder 80 is disposed in the through hole 90c of the sleeve 90. Next, with the second end face 90b of the sleeve 90 in contact with the front end face 60a of the holder 60 and the front end face 80a of the holder 80 in contact with the front end face 50a of the holder 50, the holder 60 and the holder 80 are aligned with each other so that each core 13b of the optical fiber assembly 10 and each core 23b of the optical fiber assembly 20 are optically coupled to each other with a low loss. In this state, the holder 80 is fixed to the sleeve 90, the sleeve 90 is fixed to the holder 60, and the holder 50 is fixed to the holder 80. These members are fixed using, for example, an adhesive or welding. Next, the holders 50, 60, and 80 and the sleeve 90 are entirely accommodated and sealed in a cylindrical housing H1. Through the above process, the optical connection assembly 1A is obtained.

In the optical connection assembly 1A, each member can be aligned while the respective central axes of the lenses 30 and 40, holders 50, 60, and 80, and the sleeve 90 are kept parallel to each other. In this case, since the possibility that a gap is generated between the members due to the inclination of each central axis can be reduced, it is not necessary to fill the gap with a fixing resin. As a result, since the filling amount of the fixing resin in the optical connection assembly 1A can be reduced, the possibility that the positional displacement of each member occurs due to the deformation of the resin associated with the aged deterioration can be reduced. Therefore, the optical connection assembly 1A improves the quality of optical transmission, and thus can maintain high reliability.

### Modification 2

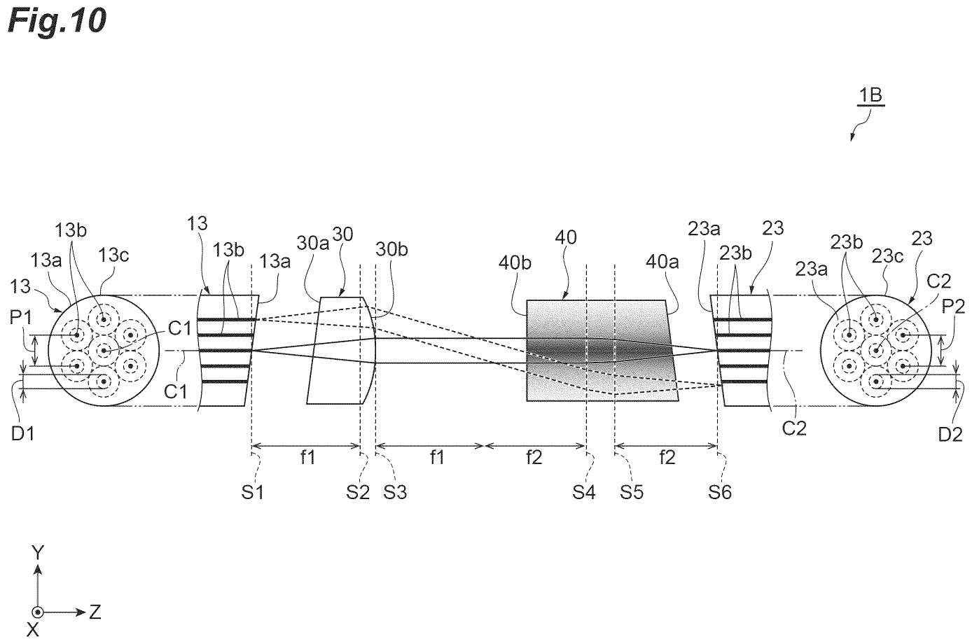

In an optical connection assembly 1B illustrated in FIG. 10, the core pitch P2 and the mode field diameter D2 of the optical fiber 23 are the same as the core pitch P1 and the mode field diameter D1 of the optical fiber 13, respectively. That is, in the optical fibers 13 and 23, relationships of P1=P2 and D1=D2 hold. In this case, in order to satisfy Equation (1), the ratio (f1/f2) of the focal length f1 of the lens 30 to the focal length f2 of the lens 40 needs to be equal to each of the ratio (P1/P2) of the core pitch P1 of the optical fiber 13 to the core pitch P2 of the optical fiber 23 and the ratio (D1/D2) of the mode field diameter D1 of the optical fiber 13 to the mode field diameter D2 of the optical fiber 23. Therefore, in the optical connection assembly 1B, the focal length f2 of the lens 40 is the same as the focal length f1 of the lens 30. That is, in the lenses 30 and 40, the relationship of f1=f2 holds. Even in the case of such an optical connection assembly 1B, the same effects as those of the optical connection assembly 1 can be obtained.

The present disclosure is not necessarily limited to the above-described embodiment and modifications, and various alterations can be made without departing from the spirit of the present disclosure. For example, in the above-described embodiment and modifications, a case where the optical fiber assemblies 10 and 20 include the optical fibers 13 and 23 that are multicore fibers has been described. At least one of the optical fiber assemblies 10 and 20 may have an optical fiber array including a plurality of optical fibers instead of the optical fibers 13 and 23. The optical fiber array may be a bundle fiber in which a plurality of single-core fibers are bundled.

Each of the number of the plurality of cores 13b of the optical fiber 13 and the number of the plurality of cores 23b of the optical fiber 23 may be 1 or more, and may be, for example, 2, 3, 4, 5, 6, or 8 or more. For example, the plurality of cores 13b may include a dummy core through which light does not pass. The plurality of cores 23b may include a dummy core through which light does not pass. In this case, the number of the plurality of cores 13b may be different from the number of the plurality of cores 23b. In the case of using such a dummy core, it is easy to align each core 13b and each core 23b, and it is possible to further reduce the influence of the return light on the quality of optical transmission.

Each of the cores 13b of the optical fiber 13 need not be arranged at an equal distance from the central axis C1 on the fiber end face 13a. The cores 13b need not be arranged in two or more rows on the fiber end face 13a, and may be arranged in one row, for example. Similarly, each of the cores 23b of the optical fiber 23 need not be arranged at an equal distance from the central axis C2 on the fiber end face 23a. The cores 23b need not be arranged in two or more rows on the fiber end face 23a, and may be arranged in one row, for example.

In the above-described embodiment and modifications, a case where the lens 30 is a plano-convex lens and the lens 40 is a GRIN lens has been described. The lens 30 may be a GRIN lens, and the lens 40 may be a plano-convex lens. One of the lenses 30 and 40 may be a lens other than the plano-convex lens. One of the lenses 30 and 40 may be, for example, a biconvex lens whose both faces are curved faces, may be an achromatic lens formed by a plurality of plates having curved faces, or may be a spherical lens formed by a sphere. The lens front face 40b of the lens 40 does not need to be a flat face perpendicular to the Z-axis along which the central axis C4 extends, and may be, for example, a flat face inclined from the plane perpendicular to the Z-axis.

In the above-described embodiment and modifications, a case where the central axis C1 of the optical fiber 13, the central axis C3 of the lens 30, the central axis C4 of the lens 40, and the central axis C2 of the optical fiber 23 coincide with each other has been described. These central axes C1, C2, C3, and C4 do not necessarily coincide with each other. For example, the central axis C1 of the optical fiber 13 may be shifted from the central axis C3 of the lens 30 in a direction perpendicular to the Z-axis, or the central axis C2 of the optical fiber 23 may be shifted from the central axis C4 of the lens 40 in a direction perpendicular to the Z-axis. In this case, the possibility that the reflected light returns to the cores 13b and 23b of emission sources as return light can be further reduced, so that the quality of optical transmission can be further improved.

In the above-described embodiment and modifications, a case where the fiber end face 13a and the lens rear face 30a close thereto are inclined in the same direction inclined about the X-axis from the plane perpendicular to the central axis C3 of the lens 30, and the fiber end face 23a and the lens rear face 40a close thereto are inclined in the same direction inclined about the X-axis from the plane perpendicular to the central axis C4 of the lens 40 has been described. The fiber end face 13a may be inclined in a direction different from the lens rear face 30a. For example, the fiber end face 13a may be inclined in a direction inclined about the X-axis from the plane perpendicular to the central axis C3, while the lens rear face 30a may be inclined in a direction inclined about the Y-axis from the plane perpendicular to the central axis C3. Similarly, the fiber end face 23a may be inclined in a direction different from the lens rear face 40a. For example, the fiber end face 23a may be inclined in a direction inclined about the X-axis from the plane perpendicular to the central axis C4, while the lens rear face 40a may be inclined in a direction inclined about the Y-axis from the plane perpendicular to the central axis C4.

### EXAMPLES

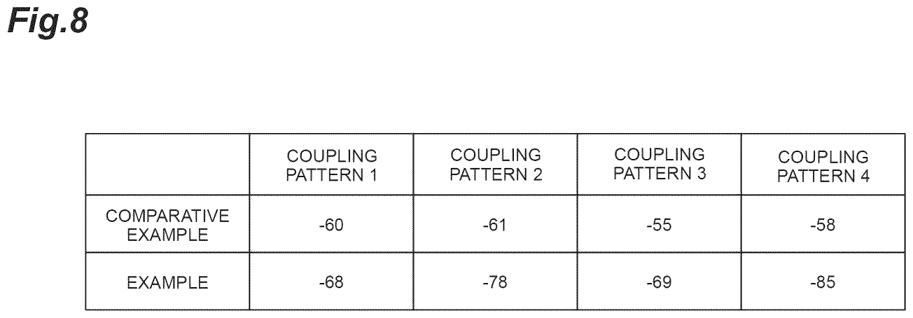

Hereinafter, Examples and Comparative Examples performed by the present inventors to confirm the effects of the present disclosure will be described with reference to FIG. 8. The present invention is not limited to this Example.

The present inventors prepared optical connection assemblies of Comparative Examples and optical connection assemblies of Examples, and measured the coupling rate of the return light in each optical connection assembly for each of the coupling patterns 1 to 4. Each of Comparative Examples and Examples includes a first optical fiber assembly having an optical fiber array, a second optical fiber assembly having a multicore fiber, and a first lens and a second lens arranged between these optical fiber assemblies. The core pitch P1 of the optical fiber array is 125 μm, and the mode field diameter D1 of the optical fiber array is 31.25 μm (=10× 125/40 μm). The multicore fiber has, for example, two cores. The core pitch P2 of the multicore fiber is 40 μm, and the mode field diameter D2 of the multicore fiber is 10 μm.

In Comparative Examples, a combination of a plano-convex lens and a plano-convex lens is used as a combination of the first lens and the second lens. In Examples, a combination of a plano-convex lens and a GRIN lens is used as a combination of the first lens and the second lens. In each of Comparative Examples and Examples, the focal length f2 of the second lens close to a multicore fiber is 0.7 mm, and the focal length f1 of the first lens close to an optical fiber array is 2.19 mm (=0.7×125/40 mm). In Examples, a GRIN lens is used as the second lens close to a multicore fiber.

In each of Comparative Examples and Examples, each of the distance between the optical fiber array and the first lens and the distance between the multicore fiber and the second lens is 0.1 mm. The fiber end face of the multicore fiber and the lens face of the second lens are inclined by 10° with respect to a plane perpendicular to the optical axis of the second lens. An anti-reflection film having a reflectance of 0.25% with respect to light propagating between the two optical fiber assemblies is formed on the fiber end face and the lens face. The fiber end face of the optical fiber array and the lens face of the first lens are inclined by 3.2° with respect to a plane perpendicular to the optical axis of the first lens. The anti-reflection film having a reflectance of 0.25% described above is also formed on the fiber end face and the lens face.

The present inventors have measured the coupling rate of the return light in the coupling patterns 1 to 4 using Comparative Examples and Examples described above. In the coupling pattern 1, the coupling rate of the return light in a case where a part of light emitted from an emission core which is one core of the multicore fiber is coupled to the emission core as return light is measured. In the coupling pattern 2, the coupling rate of the return light in a case where a part of light emitted from an emission core of the multicore fiber is coupled to the adjacent core adjacent to the emission core as return light is measured. In the coupling pattern 3, the coupling rate of the return light in a case where a part of light emitted from an emission core of the optical fiber array is coupled to the emission core as return light is measured. In the coupling pattern 4, the coupling rate of the return light in a case where a part of light emitted from an emission core of the optical fiber array is coupled to the adjacent core adjacent to the emission core as return light is measured.

FIG. 8 shows measurement results obtained by measuring the coupling rate of the return light in Comparative Examples and Examples for each of the coupling patterns 1 to 4. As shown in FIG. 8, it is found that, in Examples in which the combination of a plano-convex lens and a GRIN lens is used, the coupling rate of the return light is reduced in any of the coupling patterns 1 to 4 as compared with Comparative Examples in which the combination of a plano-convex lens and a plano-convex lens is used. From this result, in Examples, it can be confirmed that the possibility that the reflected light returns to the emission core is reduced, and the quality of optical transmission is further improved.

1. An optical connection assembly comprising:
a first optical fiber assembly including a first fiber end face and a plurality of first cores extending from the first fiber end face;
a second optical fiber assembly including a second fiber end face facing the first fiber end face and a plurality of second cores extending from the second fiber end face and optically coupling to the plurality of first cores;
a first lens including a first lens rear face facing the first fiber end face and a first lens front face facing away from the first lens rear face, the first lens being disposed between the first fiber end face and the second fiber end face; and
a second lens including a second lens rear face facing the second fiber end face and a second lens front face facing away from the second lens rear face, the second lens being disposed between the first lens front face and the second fiber end face, wherein
each of the first fiber end face and the first lens rear face is inclined with respect to a plane perpendicular to a central axis of the first lens,
each of the second fiber end face and the second lens rear face is inclined with respect to a plane perpendicular to a central axis of the second lens,
the first lens is a lens in which at least one of the first lens rear face and the first lens front face is a curved face, and
the second lens is a GRIN lens in which each of the second lens rear face and the second lens front face is a flat face.

2. The optical connection assembly according to claim 1, wherein a second core pitch, which is an interval between two second cores adjacent to each other among the plurality of second cores in the second fiber end face, is smaller than a first core pitch, which is an interval between two first cores adjacent to each other among the plurality of first cores in the first fiber end face,
a mode field diameter of each of the plurality of second cores is smaller than a mode field diameter of each of the plurality of first cores, and
a focal length of the second lens is shorter than a focal length of the first lens.

3. The optical connection assembly according to claim 1, wherein the first lens rear face is a flat face inclined with respect to the plane perpendicular to the central axis of the first lens, and
the first lens front face is a curved face which is convex away from the first lens rear face.

4. The optical connection assembly according to claim 1, wherein the second lens rear face is an inclined face inclined with respect to the plane perpendicular to the central axis of the second lens, and
the second lens front face is a vertical face perpendicular to the central axis of the second lens.

5. The optical connection assembly according to claim 1, wherein the first fiber end face and the first lens rear face are disposed in parallel to each other, and
the second fiber end face and the second lens rear face are disposed in parallel to each other.

6. The optical connection assembly according to claim 1, wherein the central axis of the first lens coincides with an extension line of a central axis of the first optical fiber assembly, and
the central axis of the second lens coincides with an extension line of a central axis of the second optical fiber assembly.

7. The optical connection assembly according to claim 1, wherein the first optical fiber assembly includes a multicore fiber including the plurality of first cores or an optical fiber array having a plurality of optical fibers each including a respective one of the plurality of first cores, and
the second optical fiber assembly includes a multicore fiber including the plurality of second cores or an optical fiber array having a plurality of optical fibers each including a respective one of the plurality of second cores.
